(19) United States
(12) Patent Application Publication
(10) Pub. No.: US 2006/0110519 A1
(43) Pub. Date: May 25, 2006

(54) Low-glycemic alcoholic beverages and methods for making same

(75) Inventors: Ellen Lauber, Farmingdale, NJ (US); Simon Gagel, Forest Hills, NY (US); Paul Bruns, Rocky Point, NY (US); Jeremy Ivie, Wading River, NY (US); Matthew Spolar, Brooklyn, NY (US); Paul Wolff, Easton, CT (US)

Correspondence Address: HOFFMANN & BARON, LLP, 6900 JERICHO TURNPIKE, SYOSSET, NY, 11791, US

(73) Assignee: Atkins Nutritionals, Inc.

(21) Appl. No.: 10/994,181

(22) Filed: Nov. 19, 2004

(51) Int. Cl. C12H 1/14

(52) U.S. Cl. 426/592

(57) ABSTRACT

The invention relates to low-glycemic alcoholic beverages comprising a low-glycemic syrup and an alcohol-containing ingredient. The low-glycemic syrup comprises a) an essence of a food, b) a low-glycemic component capable of extracting an essence from a food, and c) an extraction enhancer.

### BACKGROUND OF THE INVENTION

The present invention relates to alcoholic beverages and syrups which are modified by an additive, such as a sweet-tasting ingredient or flavorant, and especially to a modification of such beverages and syrups so as to reduce their glycemic impact on the consumer.

Liqueurs, also known as cordials, are sweet, flavor-infused spirits. Liqueurs typically contain 23 to 70% alcohol per volume. The word liqueur comes from the Latin liquifacere (“to dissolve”) and refers to the dissolving of flavorings into spirits. Liqueurs are categorized according to the flavoring material used in a particular preparation. Fruit liqueurs are made with berries, fruits, and citrus fruit peel. Nut liqueurs are made with nuts, beans and pits. Plant liqueurs are made with flowers, aromatic herbs, bark, roots, grains, spices and cloves.

Two methods are used to produce liqueurs, i.e., the distillation method and the steeping method. In the distillation method, flavoring materials are steeped in a distilled spirit in large stainless steel vats or oak casks for several weeks. During this time the mixture is stirred at regular intervals. The whole mixture is then filtered and distilled.

In the steeping method, fruits/plants are individually selected, de-stemmed, pitted and/or crushed before being steeped in a distilled spirit for about six to eight months. During this time, the mixture is heated. The spirit absorbs the aroma and taste of the selected fruit. The whole mixture is then filtered. After filtration, since the fruit/plant still contains some spirit, the fruit/plant is distilled to extract the last drop of flavor, and this extract is added to the mixture.

Common to both methods is the blending phase. In this phase, sugar syrup, honey, demineralized water and, optionally, artificial colors are added to the filtered product. Sugar syrup is added in excess of 2½ percent of the volume. The young liqueur is aged for about 3 weeks, filtered, aged again for several months, and then bottled.

The sugar syrups added to liqueurs consist of simple sugars, i.e. sucrose and fructose. In addition to liqueurs, other alcoholic beverages are modified by the addition of sweetening/flavoring components containing simple sugars. For example, wine and malt beverages are thickened and sweetened. Similarly, sweetening/flavoring components are added to beer to form flavored beer, such as cider beer.

The consumption of simple sugars found in sweetened alcoholic beverages currently on the market leads to a significant rise in blood glucose levels in the body. This rise in blood glucose levels is termed the “glycemic response.” Carbohydrates which elicit such a response are termed “glycemic carbohydrates,” “digestible carbohydrates” or “available carbohydrates.”

Blood glucose is used by the body to provide immediate energy, or is stored as glycogen in the liver and muscles to be utilized when required by the body's energy demands. Excess glucose, i.e., glucose which is not used as a source of energy or could not be stored as glycogen, is converted to adipose tissue, i.e. fat. Accordingly, chronic excess high blood glucose levels often lead to weight gain and obesity.

Accordingly, controlling blood glucose levels can be a critical factor in achieving weight loss. In fact, it has been found that effective weight reduction can be achieved with a diet which minimizes blood glucose levels to the point of inducing ketosis in the body. During such ketosis, fat is utilized as the primary fuel source rather than being stored in the body. (Robert C. Atkins, MD, Dr. Atkins' New Diet Revolution (2002)).

Additionally, high blood glucose levels are especially dangerous for diabetics. In diabetes, the body's mechanism for the control of blood glucose levels is defective. Consumption of simple sugars, as found in liqueurs, results in glucose remaining in the blood for longer than normal. In the worst case, a high level of blood glucose can cause diabetic coma. In other cases, long term effects of high blood glucose levels are associated with numerous disease conditions, such as heart disease, stroke, loss of vision, loss of nerve and/or kidney function, and increased susceptibility to infection. Recent studies have shown that these long term effects of diabetes can be greatly reduced by keeping blood glucose levels under control.

Other metabolic disorders may be related to, or caused by, persistently high levels of blood glucose. Examples of such disorders include: insulin resistance; hyperinsulinism, which can lead to type II diabetes; hypoglycemia; hyperlipidemia; and hypertriglyceridemia.

The control of blood glucose levels in individuals without metabolic disorders is also highly desirable. For example, recent studies have shown that even transiently high blood glucose levels can lead to disease. For example, glucose molecules can attach to amino groups in tissue proteins and cross-link them into stiff yellow-brown compounds known as advanced glycation endproducts (AGEs). AGEs may destroy normal protein structure, inhibit protein physiological function and cause damage that leads to irreversible disease conditions in vital organs. The rate of AGEs accumulation and the degree of stiffness they produce are proportional to blood glucose levels, and the length of time high levels persist.

Consumption of sweetened alcoholic beverages, such as liqueurs, elicits high glycemic responses. Therefore, such consumption, particularly habitual consumption, poses health concerns such as those described above. Thus, there remains a need for sweet-tasting alcoholic beverages which do not elicit a high glycemic response.

### SUMMARY OF THE INVENTION

In one aspect, the present invention is a low-glycemic alcoholic beverage which includes a low-glycemic syrup and an alcohol-containing ingredient. The low-glycemic syrup includes an essence of a food; a low-glycemic component which is capable of extracting an essence of a food; and an extraction enhancer.

The essence of a food is the flavors, aromas, colors, and/or nutrients of the food. Preferably, the essence of the food is derived from one or more fruits, vegetables, nuts, plants, and/or any aspects thereof. Examples of aspects of foods are peels, rinds, pulp, seeds, juice, grain, bark, flowers, spices, leaves, beans, herbs, oleoresins, extracts and concentrates.

Preferred examples of fruits include citrus fruits, tropical fruits, berries, drupaceous fruits, gourds, pomes, and tomatoes. Preferred examples of plants, or plant aspects, include coriander, wormwood, chinchena bark, elder flowers, angelica root, orris, alpine flowers, edelweiss, gentian, cloves, cardamon, fennel, thyme, cocoa, vanilla, nutmeg, cinnamon, armoise, quinine, chamomile, absinthe, sage, ginger, licorice, mint, parsley, cola nuts, and legumes, e.g., peanut and soy bean. Preferred examples of nuts include almond, cashew, hazel nut, walnut and Brazilian nut. Preferred examples of vegetables include sweet potato, sweet corn, squash, beets, carrots and cruciferous vegetables.

The low glycemic component comprises one or more glycemic substances. Preferred examples of low glycemic substances include linear fructans, e.g., inulin and oligofructose; and polydextrose. Preferred examples of extraction enhancers include glycerin, propylene glycol and triacetin.

Preferably, the extraction enhancer and the low-glycemic component are in a ratio by weight of from about 1:3 to each other to about 1:1 to each other.

Preferred examples of the alcohol-containing ingredients include grain alcohol, rum, tequila, brandy, marc, mescal, beer, wine or combinations thereof. Examples of a grain alcohol include schnapps, vodka, whiskey, gin, kummel, aquavit, or a combinations thereof.

In another aspect, the present invention is a method of producing a low-glycemic alcoholic beverage including combining a food source; a low-glycemic component; an extraction enhancer; and an alcohol-containing ingredient.

Preferably, the food source; the low-glycemic component; and extraction enhancer are combined first to form a food solids mixture. These ingredients are kept in contact for a time period that is sufficient to transfer the essence of the food source to the low glycemic component thereby producing a low-glycemic syrup. Preferably, the time period is from about a minute to about forty-eight hours.

The method further comprises separating the low-glycemic syrup from the food solids. Examples of methods of separation include filtration, reverse osmosis, a chromatographic method, liquid-liquid extraction, or combinations thereof. The alcohol-containing ingredient and the low-glycemic syrup are then combined, thereby producing the low-glycemic alcoholic beverage.

The low-glycemic alcoholic beverages of the present invention provide several advantages over sweetened and/or flavored alcoholic beverages on the marketplace today.

For example, unlike sweetened alcoholic beverages, the low-glycemic alcoholic beverages of the present invention do not contain glycemic carbohydrate sweeteners. Instead the beverages contain indigestible carbohydrates, such as linear fructans, e.g., inulin and oligosaccharides. Since these carbohydrates are not digested, they do not elicit a glycemic response. Accordingly, consumption of the beverages of the present invention do not pose the health concerns associated with high blood glucose levels, such as obesity and diabetes.

Additionally, the consumption of sweetened alcoholic beverages by individuals with metabolic disorders, such as diabetes, lead to deleterious or even fatal consequences. In contrast, these individuals could freely consume the low-glycemic alcoholic beverages of the present invention without such consequences.

Moreover, alcoholic beverages of the present invention can be formulated to have more favorable organoleptic qualities vis-à-vis sweetened alcoholic beverages currently on the market. Such qualities include stronger natural flavors, and richer aromas and colorings. These qualities are highly pleasing to the consumer.

Furthermore, the production of the low-glycemic alcoholic beverages is more efficient than the production of sweetened and/or flavored alcoholic beverages with respect to the use of materials, and energy and time requirements. Owing to a more efficient process, the production of the beverages of the present invention is more economical than the production of currently available sweetened alcoholic beverages.

For example, a reduced amount of flavoring materials is needed to produce the low glycemic alcoholic beverages vis-à-vis currently available sweetened alcoholic beverages, such as liqueurs. A reduced amount of flavoring material is possible since in the process of the present invention, the food essence becomes highly concentrated in the low-glycemic component.

Additionally, the time required to make the beverages of the present invention is greatly reduced. For example, in order for currently available sweetened alcohol beverages to obtain the essence of a flavoring material, a spirit is required to be in contact with a flavoring material for several weeks to several months; and distillation may be required. In contrast, the process of the present invention allows the low glycemic alcoholic beverages to acquire the essence of a flavoring material within a couple of days, and distillation is not required.

Moreover, in the production of currently available sweetened alcoholic beverages, while the spirit is in contact with a flavoring material, the system must be heated. In contrast, the process of the present invention does not require heating.

Furthermore, the filtration process is less time consuming and less arduous in the method of the present invention vis-à-vis the methods for making other sweetened alcoholic beverages. In the present method, solids of the flavoring material are filtered out of the low-glycemic syrup. Since the syrup does not contain the spirit, only a small volume is required to be filtered. The spirit is then added to form the full volume of the end product, such as a liqueur.

In contrast, in the process of making the sweetened alcoholic beverages currently on the market, solids of the flavoring material are filtered out of a flavor-infused spirit, i.e. solids are filtered out of the end product. Thus, large volumes are required to be filtered.

For a better understanding of the present invention, reference is made to the following description.

### DETAILED DESCRIPTION OF THE INVENTION

In one aspect, the invention relates to low-glycemic syrups and low glycemic alcoholic beverages containing such syrups. For the purposes of this specification, “low-glycemic” syrups and alcoholic beverages are syrups and beverages which elicit a low glycemic response upon consumption. The term “low-glycemic” includes “non-glycemic,” i.e., syrups and beverages which elicit no glycemic response.

The glycemic response elicited by consumption of a food product can be determined by several methods. For example, the glycemic response can be determined by measuring the glycemic response in a healthy individual after consumption of the product. A healthy individual is someone without a metabolic disorder, such as diabetes. A low-glycemic response is defined an insignificant rise in the blood glucose level in an individual after consuming the product. Preferably, the post-consumption blood glucose level is compared to a fasting blood glucose level.

The glycemic response elicited by a food product upon consumption can also be determined by calculating the glycemic index (GI) of the beverage. GI is defined as the glycemic response elicited by a food containing twenty-five or fifty grams of glycemic carbohydrate expressed as a percentage of the glycemic response elicited by twenty-five or fifty grams of a glycemic carbohydrate of a standard food, such as white bread or an oral glucose solution (Wolever et al., Journal of the American College of Nutrition 8(3):235-247 (1989)). The GI of a food product can be calculated by summing the known or measured GIs of the individual components contained in the beverage. The glycemic response-lowering effects of certain fibers, fats, and proteins may also be included in a GI calculation. A food product which has a GI value of about 50 or below is low-glycemic.

The low-glycemic alcoholic beverage includes a low-glycemic syrup and an alcohol-containing ingredient. The syrup includes a) an essence of a food, b) a low-glycemic component which is capable of extracting an essence from a food, and c) an extraction enhancer.

Essences of a food are the flavors, colors, aromas, nutrients, and the like, of the food. Some examples of nutrients include vitamins, such as tocotrienol; antioxidants; flavanoids, such as nobiletin and polymethoxylated flavone; phytochemicals; and minerals. Phytochemicals include antioxidants; phytoestrogens; carotenoids, such as carotene and lycopene; flavanoids; allyl sulfide; phytosterols; and plant pigments, such as the anthocyanines.

In one embodiment, the essence of a food can be derived from, for example, one or more fruits, plants, vegetables, nuts, and any combination thereof. The essence can be derived from the whole food or any aspect of the food. An aspect of a food is any part of a food. Examples of aspects of fruits and/or vegetables include peels, rinds, pulps, seeds, juices, extracts, and concentrates. Examples of aspects of plants include grains, barks, flowers, spices, leaves, juices, beans, seeds, oleoresins, extracts, concentrates and herbs.

Some examples of fruits from which an essence can be derived include citrus fruits, tropical fruits, berries, gourds, pomes, tomatoes and drupaceous fruits. Some examples of suitable citrus fruits include grapefruits, lemons, tangerines, oranges, and limes. Some examples of suitable tropical fruits include bananas, kiwis, mangos, papayas, pineapples, avocados, coconuts, plantains and figs. Some examples of suitable berries include cranberries, blueberries, strawberries, currants, raspberries and grapes. Some examples of suitable gourds include pumpkins and melons. Some examples of suitable pomes include apples, pomegranate and pears. Some examples of suitable drupaceous fruits include peaches, apricots, plums and cherries.

Some examples of plants include the aromatic plants and legumes. Examples of suitable aromatic plants, and their aspects, include coriander, wormwood, chinchena bark, elder flowers, angelica root, orris, alpine flowers, edelweiss, gentian, cloves, cardamom, fennel, thyme, cocoa, vanilla, nutmeg, cinnamon, armoise, quinine, chamomile, absinthe, sage, ginger, licorice, peppermint, spearmint, rosemary and parsley. Examples of legumes include peanuts and soybeans. Other examples of plants, and aspects of plants, include cola nuts; seaweed, e.g., kelp; chlorophylls and wheat grass.

Some examples vegetables include sweet potato, sweet corn, squash, beets, carrots and cruciferous vegetables, e.g., broccoli. Some examples of nuts include almonds, cashews, hazel nuts, walnuts, and Brazilian nuts.

Preferably, the essence is derived from a low-glycemic food or a low-glycemic aspect of a food. Examples of low glycemic foods include raspberry, cranberry and coconut. Examples of low-glycemic aspects of food include citrus peel, such as lemon or orange peel, in particular, bitter orange peel; and banana, mango, or pineapple skins. Examples of low-glycemic concentrates/extracts include vanilla, lemon peel, almond, and herb concentrates/extracts. The concentrates/extracts also include those that are artificial, such as vanillin.

The low-glycemic component which is capable of extracting an essence from a food is one or a combination of low-glycemic substances. For the purposes of this specification, the capability of “extracting an essence from a food” means that the component is capable of assimilating, absorbing and/or incorporating the essence.

In addition to the capability of extracting an essence, the component preferably enhances the organoleptic properties of the low-glycemic alcohol-containing beverage.

For example, the low-glycemic component can function as a sweetener, sweetening-enhancer, color enhancer, flavor modifier, or a combination thereof.

The low-glycemic component preferably comprises soluble fiber. Besides the more well-known health benefits of soluble fiber, the soluble fiber tends to lower the glycemic response, thereby helping to make the syrup low-glycemic.

Preferred examples of low-glycemic substances of the low-glycemic component include linear fructans, i.e., inulin and oligofructose (i.e., fructo-oligosaccharide); polydextrose; and combinations thereof.

Inulin is a polydisperse mixture of linear fructose polymers and oligomers. The fructose units in these polymers and oligomers are each linked by β(2-1) bonds. A glucose unit typically resides at the end of each fructose chain and is linked by an α(1-2) bond. The chain lengths of these polymers and oligomers range from 2 to 60 units, with an average degree of polymerization (DP) of approximately ten.

Oligofructose is a subset of the polydisperse mixture that makes up inulin. In particular, oligofructose contain 2 to 10 fructose units linked by β(2-1) bonds, with a average DP of approximately four (IUB-IUPAC Joint Commission on Biochemical Nomenclature 1982). As with inulin, the fructose chains of oligofructose typically have terminal glucose units.

In their natural forms, inulin and oligofructose are storage carbohydrates found in numerous edible plant species. For example, the roots of plants of the asteraceae family contain inulin and oligofructose. Examples of such roots include burdock root, dandelion root, elecampane root, and chicory root (i.e. Cichorium intybus). Other plants sources of inulin and oligofructose include banana, artichoke, leek, onion, asparagus, wheat, barley, rye, garlic, and the Chinese herb codonopsis.

Inulin and oligofructose suitable for the present invention can be extracted from plants. Commercially available inulin and oligofructose are typically extracted from the chicory root. The extract from chicory root typically contains about 6 to 10 wt % simple sugars, i.e. glucose, fructose and sucrose. Inulin and oligofructose used in the present invention can also be synthetically produced. For example, oligofructose can be derived by hydrolyzing inulin. For instance, inulin can be broken down using an inulase enzyme. Also, oligofructose can be synthesized from sucrose by transfructosylation, which is accomplished by means of an enzyme, β-fructofuranosidase, that links additional fructose monomers to the sucrose molecule. Oligofructose formed in this manner typically contain 2 to 4 fructose units linked to a terminal glucose. The glucose and fructose molecules formed as by-products of the process, as well as any unreacted sucrose, can be removed with chromatography.

Any form of inulin and/or oligofructose are useful for the present invention. For 30 example, semi-refined, substantially refined, and chemically altered forms of inulin and/or oligofructose are applicable to the present invention. Also, powder, liquid, and solution forms are suitable. Some commercial forms of inulin are available under the trade names Raftiline® and Frutafit®. Some commercial forms of oligofructose are available under the trade names Raftilose®, Frutalose™, and NutraFlora®. Each of these commercial forms of inulin and oligofructose contain some simple sugars, e.g., they contain about 5 to 10 wt % simple sugars.

Inulin and oligofructose provide sweetness to the alcoholic beverages. However, because of their β(2-1) linkages, inulin and oligofructose are virtually indigestible. Accordingly, consumption of inulin and oligofructose elicit little or no glycemic response. Additionally, inulin and oligofructose are fermented by microflora, primarily lactic acid bacteria, in the large intestine. For this reason, they provide the same positive health benefits as other soluble fiber.

Polydextrose is a randomly highly branched polymer of glucose with an average molecular weight of about 1,500 to about 18,000. Polydextrose is water-soluble, low-glycemic, and non-cariogenic. Polydextrose is digested by the body in a manner consistent with dietary fibers. Polydextrose is also known by the trade name Litesse®.

Polydextrose is available in several forms, all of which are applicable to the present invention. For example, polydextrose can be in powder form. One example of a polydextrose powder is Polydextrose A, an amorphous, slightly acidic powder of polydextrose. Another example of a polydextrose powder is Polydextrose K, which has a near neutral pH. Numerous other powder forms of polydextrose exist, all of which are within the scope of the invention.

Polydextrose can also be in the form of a solution or liquid. The solution or liquid forms of polydextrose can also be in the form of a syrup. All such solution or liquid forms of polydextrose are within the scope of the invention. One example of a suitable polydextrose syrup is Polydextrose N, which is a 70 percent aqueous solution of polydextrose that has a near neutral pH. Several other forms of polydextrose syrups and solutions are possible.

Examples of other suitable low-glycemic substances of the low-glycemic component include glycerol monostearate: propylene glycol alginate; lecithin; sodium alginate; potassium alginate; glycerol triacetate; palmitic acid; oleic acid; stearic acid; sodium stearate; potassium stearate; glyceryl lecithin; propylene glycol monostearate; acetylated monoglyceride; hydrogenated vegetable oils; diglycerides; sugar esters; triglycerides; cellulose, e.g., medium chain triglycerides; hydroxypropyl cellulose; methyl cellulose; hydroxypropyl methyl cellulose; ethylmethylcellulose; carboxymethylcellulose; sodium carboxy methyl cellulose; carrageenan; xanthan gum; gelatin; agar; pectin; casein; albumin; soy protein; carob; tragacanth; locust bean gum; guar gum; acacia; polyoxyethylene sorbitan monolaurate; polyoxyethylene sorbitan monooleate; polyoxyethylene sorbitan monopalmitate; polyoxyethylene sorbitan monostearate; polyoxyethylene sorbitan tristearate; sodium stearoyl-2-lactylate; calcium stearoyl-2-lactylate pectin; stearyl tartrate; sorbitan monostearate; sorbitan tristearate; sorbitan monolaurate; sorbitan monooleate; sorbitan monopalmitate; and the like.

In one embodiment, the low-glycemic component comprises one low-glycemic substance. In a preferred embodiment, the low-glycemic component comprises a combination of low-glycemic substances.

For example, the low-glycemic component can comprise a combination of a first low-glycemic substance and a different second low-glycemic substance. The first and second low-glycemic substances are combined in any suitable amounts by weight of the low-glycemic component. For example, the first or second low-glycemic substance can independently be in an amount by weight of the low-glycemic component of about 1 percent, 5 percent, 10 percent, 20 percent, 25 percent, 40 percent, 50 percent, 60 percent, 75 percent, 80 percent, 90 percent, 95 percent, 99 percent, and so on.

The extraction enhancer is any low-glycemic substance which enhances the ability of the low glycemic component to extract an essence from a food. Preferred examples of extraction enhancers include glycerin, propylene glycol, triacetin, and combinations thereof.

The extraction enhancer and the low-glycemic component are used in any desired amounts. Preferably, the ratio by weight of the extraction enhancer to the low-glycemic component ranges from about 1:3 to about 3:1, more preferably the ratio is about 1:1. The low-glycemic component and the extraction enhancer together are referred to as the low-glycemic extractant

In a preferred embodiment, the low-glycemic extraction enhancer is glycerin and the low-glycemic component is inulin. In another preferred embodiment, the low-glycemic extraction enhancer is glycerin and the low-glycemic component is polydextrose.

The low-glycemic extractant can further contain a salt ingredient. The salt ingredient includes any compound or combination of compounds that imparts a salty taste. Preferably, the salt ingredient is consumable sodium chloride. Other suitable salt ingredients include, for example, artificial salt, soy sauce and sea salt. The concentration of the salt ingredient in the low-glycemic component can be any desired concentration. Preferably, the salt ingredient is in an amount of 0.2 percent to 2.0 percent by weight of the low-glycemic component.

The low-glycemic alcohol-containing ingredient contains a consumable, preferably distilled, alcohol that is low-glycemic. Preferably, the alcohol in the alcohol-containing ingredient is ethyl alcohol. Examples of the alcohol-containing ingredient include grain alcohol, rum, tequila, brandy, marc, mescal, beer, wine or combinations thereof. Examples of a grain alcohol include schnapps, vodka, whiskey, gin, kummel, aquavit, or a combination thereof. Other examples of alcohol-containing ingredients are extracts/concentrates, such as, for example, anise, coconut, coffee, maple, peppermint, orange peel, lemon peel, and vanilla.

In another aspect, the invention relates to methods of producing the low-glycemic syrups and low-glycemic alcoholic beverages described above. The methods include any method useful for combining a food source, a low-glycemic component, and a low glycemic extraction enhancer to form a low-glycemic syrup. An alcohol-containing ingredient is combined with the syrup to produce a low-glycemic alcoholic beverage wherein the beverage has the essence of the food source. A food source comprises one or more of the foods, or food aspects, as described above. A low-glycemic component, extraction enhancer, and an alcohol-containing ingredient are also described above.

The low-glycemic component and extraction enhancer together form the extractant. In a preferred embodiment, an aqueous mixture is formed from the extractant. The ratio of the water to the extractant preferably ranges from about 10:90 to about 1:99, more preferably from about 5:95 to about 2:99. Most preferably, the ratio is about 3:97.

A food source is then placed into contact with the aqueous solution of the extractant to form a food solids mixture. Preferably, the food source and the extractant are mixed or blended together.

The food source comprises one or more of the foods, and aspects the foods, described above, i.e. fruits, vegetables, plants and nuts, and their aspects. The food source can be in any form desired. For example, the food source can be whole, i.e., essentially in its natural state without alteration or pre-treatment. A whole food may be desirable in many situations, most notably when delicate components of the food source are desired to be preserved or unaltered. Alternatively, the food source is treated in some way or changed in form, such as by being steeped, de-pitted, sliced, de-stemmed, blanched, boiled, chopped, mashed, ground and/or blended. Additionally, the food source can be enzymatically treated for flavor modification and/or carbohydrate reduction. Examples of such enzymes include cellulase and hemi-cellulase. Such an enzymatically treated food source may be further treated by removing volatile alcohols. Other food source treatments are also within the scope of the invention.

Once the food source and the aqueous solution of the extractant are placed in contact with each other, the food source makes up about 1 wt % to about 75 wt % of the food solids mixture. The exact amount varies accordingly to the particular food sources and extractants, and their pretreatments; and the desired characteristics of the end product.

The food source and the extractant are kept in contact for a period of time that is at least long enough to extract the essence of the food source into the low-glycemic component. That is, these ingredients are kept in contact for the period of time that is at least sufficient for the essence to be transferred from the food source to the low-glycemic component. This method step is also referred to as the extraction step. The resulting essence-containing low-glycemic extractant is the low-glycemic syrup.

The amount of time the food source is kept in contact with the low-glycemic extractant is dependent upon the particular starting ingredients. For example, where a desired essence of a food source is extracted by the low-glycemic extractant in a short amount of time, a sufficient time for contact may be approximately a minute or a few minutes. On the other hand, where a desired essence of a food source is extracted by the low-glycemic extractant in a longer period of time, a sufficient contact time may be about one hour to about 48 hours, or several days or about a week.

The amount of time the food source is kept in contact with the low-glycemic extractant is also dependent upon additional factors aside from the degree of extraction of food essences. For example, the contact time also depends upon the desired qualities of the resulting low-glycemic syrup, such as organoleptic properties. Additional factors to be considered include the rate of degradation of the food source, and operational and cost efficiencies.

The extraction step can be performed without heating and at atmospheric pressure. Additionally, the extraction step can be performed in the absence of any additional treatment techniques, such as distillation, ultrasound and enzymatic treatments.

Alternatively, the extraction step can be performed with any adjustments in temperature, pressure and/or in the presence of additional techniques. For example, the extraction step can be performed at elevated temperature levels, i.e., by the application of heat. The extraction step can also be performed at altered pressures. The extraction step can also be performed in an oxygen-restricted or oxygen-free environment. In addition, the extraction step can be accompanied by other techniques, such as ultrasound.

Before the low-glycemic syrup is combined with an alcohol-containing ingredient, the food solids are separated from the syrup. The low-glycemic syrup can be separated from food solids by several methods. Examples of preferred separation methods include filtration and microfiltration. Other suitable separation methods include reverse osmosis, chromatographic methods, liquid-liquid extraction techniques, and centrifugation. Any of the foregoing separation methods may be combined as found desirable or appropriate.

The low-glycemic syrup is then contacted with the alcohol-containing ingredient. No distillation is required. The alcohol content by weight of the low-glycemic alcoholic beverage is any alcohol content that is desired or appropriate. For example, the alcohol content of the low-glycemic alcoholic beverage of the present invention is typically in the range of 1.5 percent to 70 percent.

The low-glycemic syrups and alcoholic beverages of the present invention can further comprise one or more optional ingredients. Some classes of optional ingredients include, for example, coloring agents, natural and artificial flavors, flavor enhancers, scents, emulsifiers, buffering agents, acidifiers, pharmaceuticals, humectants, preservatives, antioxidants, vitamins, minerals, real and artificial low-glycemic sweeteners, and carbon dioxide gas for carbonation.

For example, the low-glycemic alcoholic beverage can comprise such coloring agents as, for example, titanium dioxide and other dyes suitable for food and drug applications, i.e., F. D.& C. dyes; such antioxidants or preservatives as, for example, sulfiting agents, butylated hydroxytoluene (BHT), butylated hydroxyanisole (BHA), or propyl gallate; such emulsifiers as, for example, glyceroyl monostearate, lecithin, casein, and glycerol triacetate; such acidifiers as, for example, citric, malic, lactic, tartaric, acetic, and phosphoric acids; natural and artificial low-glycemic sweeteners such as, for example, saccharin, low-glycemic sugar alcohols, low-glycemic oligosaccharides, 2,4-dihydroxybenzoic acid, aspartame, stevia, sucralose, acesulfame-K, cyclamate, Lo Han Guo; such vitamins and minerals as, for example, vitamins A, D, E, B₁, B₂, B₆, B₁₂, K, niacin, pantothenic acid, folic acid, biotin, and beta carotene; and such flavor enhancers as monosodium glutamate, monopotassium glutamate, sodium guanylate, disodium inosinate, and glycine.

The pH and water activity of the low-glycemic syrup, extractant, or alcoholic beverage are not critical to the goals of the invention. However, the pH and water activity can be monitored and/or adjusted to modify the characteristics of the beverage, such as organoleptic properties, microbial resistance, and preservation.

For example, in a preferred embodiment, the low-glycemic syrup, extractant, and/or alcoholic beverage has a minimum pH of about 2 and a maximum pH of about 9. The water activity of the low-glycemic syrup and/or extractant is preferably a minimum of about 0.4 to a maximum of about 0.9.

It is known that the growth of most food spoiling bacteria and molds is severely restricted at water activities at or below 0.8. Therefore, when storage of the low-glycemic syrup and/or extractant is contemplated, a water activity of no greater than about 0.8 is typically preferable.

In one embodiment of the invention, the food solids are not filtered out of the alcoholic beverage, and thus the resulting alcoholic beverage further comprises all or some of the food solids whose essence were transferred into the extractant.

In another aspect of the present invention, the low-glycemic syrup can be used to prepare other types of products besides alcohol-containing beverages. For example, the consistency of the syrup can be adjusted so as to make it suitable for use as low-glycemic sauces and toppings, in particular dessert sauces/toppings. Alternatively, the consistency of the syrup can be adjusted so as to make it suitable for use as low-glycemic fillings, in particular for fillings for baked goods, e.g., cakes and pies, and confectionary, e.g., chocolates; and for use as low-glycemic creams, puddings, dressings, and soups, e.g., gazpacho. In this aspect of the invention, the low-glycemic syrup can comprise alcohol, or the low-glycemic syrup can be alcohol free. Alternately, the low-glycemic syrup can be used to prepare pharmaceuticals, such as, for example, cough syrups and digestive aids.

In this aspect of the invention, in addition to the ingredients described above, the low glycemic syrup can further comprise bulking agents, thickeners, plasticizers and/or gelling agents. Examples of bulking agents include calcium carbonate, magnesium carbonate, alumina, aluminum hydroxide, aluminum silicate, talc, tricalcium phosphate, cellulose, and the like. Examples of thickeners include alginates, methyl cellulose, carrageenan, xanthan gum, gelatin, carob, tragacanth, and locust bean gum. Examples of plasticizers include lanolin, glyceryl lecithin, hydrogenated vegetable oils, diglycerides, and triglycerides.

### EXAMPLES

Examples have been set forth below for the purpose of illustration and to describe the best mode of the invention at the present time. The scope of the invention is not to be in any way limited by the examples set forth herein.

Examples 1-8 describes the preparation of some extractants of the present invention. These extractants can be combined with an alcohol-containing ingredient, or can be used to prepare other types of products, as described above.

### Example 1

### Preparation of Low-Glycemic Extractant (I-1)

Approximately 50 grams of glycerin and approximately 50 grams of polydextrose syrup were combined and mixed with approximately 1 gram of sodium chloride salt at room temperature (approximately 24-25° C.). The mixture had a pH of approximately 3.8 and a water activity of approximately 0.47.

### Example 2

### Preparation of Low-Glycemic Extractant (I-2)

Approximately 50 grams of glycerin and approximately 50 grams of Raftilose L85™ were combined and mixed with approximately 1 gram of sodium chloride salt at room temperature (approximately 24-25° C.). The mixture had a pH of approximately 4.6 and a water activity of approximately 0.43.

### Example 3

### Preparation of Low-Glycemic Extractant (I-3)

Approximately 50 grams of glycerin and approximately 50 grams of Frutalose L85™ were combined and mixed with approximately 1 gram of sodium chloride salt at room temperature (approximately 24-25° C.). The mixture had a pH of approximately 3.8 and a water activity of approximately 0.44.

### Example 4

### Preparation of Low-Glycemic Extractant (I-4)

Approximately 50 grams of glycerin and approximately 50 grams of NutraFlora® were combined and mixed with approximately 1 gram of sodium chloride salt at room temperature (approximately 24-25° C.). The mixture had a pH of approximately 4.9 and a water activity of approximately 0.46.

### Example 5

### Preparation of Low-Glycemic Extractant (II-1)

Approximately 40 grams of glycerin and approximately 60 grams of polydextrose syrup were combined and mixed with approximately 1 gram of sodium chloride salt at room temperature (approximately 24-25° C.). The mixture had a pH of approximately 3.6 and a water activity of approximately 0.57.

### Example 6

### Preparation of Low-Glycemic Extractant (I-2)

Approximately 40 grams of glycerin and approximately 60 grams of Raftilose L85™ were combined and mixed with approximately 1 gram of sodium chloride salt at room temperature (approximately 24-25° C.). The mixture had a pH of approximately 4.2 and a water activity of approximately 0.47.

### Example 7

### Preparation of Low-Glycemic Extractant (II-3)

Approximately 40 grams of glycerin and approximately 60 grams of Frutalose L85™ were combined and mixed with approximately 1 gram of sodium chloride salt at room temperature (approximately 24-25° C.). The mixture had a pH of approximately 3.6 and a water activity of approximately 0.51.

### Example 8

### Preparation of Low-Glycemic Extractant (II-4)

Approximately 40 grams of glycerin and approximately 60 grams of NutraFlora® were combined and mixed with approximately 1 gram of sodium chloride salt at room temperature (approximately 24-25° C.). The mixture had a pH of approximately 4.7 and a water activity of approximately 0.54 or lower.

Examples 9-12 describe the extraction of a food essence with some of the low-glycemic extractants of the present invention.

### Example 9

### Extraction of Food Essence with Low-Glycemic Extractant

Approximately 11.0 grams of low-glycemic extractant (I-2) from Example 2 was mixed with approximately 10.8 grams of fresh grounded peaches at room temperature (approximately 24-25° C.). The mixture was allowed to stand for 24-72 hours at room temperature. The mixture was then filtered. The water activity of the mixture was approximately 0.87.

### Example 10

### Extraction of Food Essence with Low-Glycemic Extractant

Approximately 11.0 grams of low-glycemic extractant (II-2) from Example 6 was mixed with approximately 10.5 grams of fresh grounded peaches at room temperature (approximately 24-25° C.). The mixture was allowed to stand for 24-72 hours at room temperature. The mixture was then filtered. The water activity of the mixture was approximately 0.89.

### Example 11

### Extraction of Food Essence with Low-Glycemic Extractant

Approximately 21.9 grams of low-glycemic extractant (I-2) from Example 2 was mixed with approximately 13.3 grams of one-half inch pieces of fresh peaches that had been previously boiled for two minutes. The mixing was performed at room temperature (approximately 24-25° C.). The mixture was allowed to stand 24-72 hours at room temperature. The mixture was then filtered. The syrup component (the extract) weighed 17.5 grams and had a water activity of approximately 0.87. The peach solids weighed 16.8 grams and had a water activity of approximately 0.88.

### Example 12

### Extraction of Food Essence with Low-Glycemic Extractant

Approximately 14.2 grams of low-glycemic extractant (II-2) from Example 6 was mixed with approximately 12.9 grams of one-half inch pieces of fresh peaches that had been previously boiled for two minutes. The mixing was performed at room temperature (approximately 24-25° C.). The mixture was allowed to stand for 24-72 hours at room temperature. The mixture was then filtered. The syrup component (the extract) had a water activity of approximately 0.88. The peach solids had a water activity of approximately 0.88.

Thus, whereas there have been described what are presently believed to be the preferred embodiments of the present invention, those skilled in the art will realize that other and further embodiments can be made without departing from the spirit of the invention, and it is intended to include all such further modifications and changes as come within the true scope of the claims set forth herein.

We claim:

1. A low-glycemic alcoholic beverage comprising:
a) an essence of a food;
b) a low-glycemic component which is capable of extracting an essence of a food;
c) a extraction enhancer, and
d) an alcohol-containing ingredient.

2. A low-glycemic alcoholic beverage according to claim 1, wherein the essence of a food comprises the flavors, aromas, colors, nutrients, or combinations thereof of the food.

3. A low-glycemic alcoholic beverage according to claim 1, wherein the essence of the food is derived from one or more fruits, vegetables, nuts, plants, any aspects thereof, or combinations thereof.

4. A low-glycemic alcoholic beverage according to claim 3, wherein the aspect of the food is peel, rind, pulp, seed, juice, grain, bark, flower, spice, leaf, bean, herb, oleoresin, an extract, a concentrate, or combinations thereof.

5. A low-glycemic alcoholic beverage according to claim 3, wherein the fruit is a citrus fruit, a tropical fruit, a berry, a drupaceous fruit, a gourd, a pome, a tomato, or combinations thereof.

6. A low-glycemic alcoholic beverage according to claim 3, wherein the plant, or plant aspect, is coriander, wormwood, chinchena bark, elder flowers, angelica root, orris, alpine flowers, edelweiss, gentian, cloves, cardamon, fennel, thyme, cocoa, vanilla, nutmeg, cinnamon, armoise, quinine, chamomile, absinthe, sage, ginger, licorice, peppermint, spearmint, rosemary, parsley, soy bean, peanut, cola nut, or combinations thereof.

7. A low-glycemic alcoholic beverage according to claim 3, wherein the nut is almond, cashew, hazel nut, walnut, Brazilian nut, or combinations therof.

8. A low-glycemic alcoholic beverage according to claim 3, wherein the vegetable is a sweet potato, sweet corn, squash, beet, carrot, cruciferous vegetable, or combinations thereof.

9. A low-glycemic alcoholic beverage according to claim 1, wherein the low-glycemic component comprises a low glycemic substance selected from the group consisting of inulin, oligofructose, polydextrose, and combinations thereof.

10. A low-glycemic alcoholic beverage according to claim 1, wherein the extraction enhancer is glycerin, propylene glycol, triacetin, or combinations thereof.

11. A low-glycemic alcoholic beverage according to claim 1, wherein the ratio by weight of the extraction enhancer to the low-glycemic component ranges from about 1:3 to about 3:1.

12. A low-glycemic alcoholic beverage according to claim 11, wherein the extraction enhancer is glycerin and the low-glycemic component is inulin.

13. A low-glycemic alcoholic beverage according to claim 11, wherein the extraction enhancer is glycerin and the low-glycemic component is polydextrose.

14. A low-glycemic alcoholic beverage according to claim 1, wherein the alcohol-containing ingredient is a grain alcohol, rum, tequila, brandy, marc, mescal, beer, wine, or combinations thereof.

15. A low-glycemic alcoholic beverage according to claim 14, wherein the grain alcohol is schnapps, vodka, whiskey, gin, kummel, aquavit, or combinations thereof.

16. A low-glycemic alcoholic beverage according to claim 1 further comprising a salt component.

17. A low-glycemic alcoholic beverage according to claim 16, wherein the salt component is in an amount of about 0.2 percent to 2.0 percent by weight of the low-glycemic component.

18. A method of producing a low-glycemic alcoholic beverage comprising combining a) a food source; b) a low-glycemic component; c) a extraction enhancer and c) an alcohol-containing ingredient.

19. A method according to claim 18, wherein the food source, the low-glycemic component and the extraction enhancer are combined first to form a food solids mixture.

20. A method according to claim 18, wherein the food source is whole, steeped, blanched, boiled, chopped, mashed, ground or blended.

21. A method according to claim 18, wherein the food source is enzymatically treated.

22. A method according to claim 19, wherein the food source, the low-glycemic component and the extraction enhancer are kept in contact for a time period that is sufficient to transfer the essence of the food source to the low glycemic component thereby producing a low-glycemic syrup.

23. A method according to claim 22, wherein the time period is from about a minute to about forty-eight hours.

24. A method according to claim 22, further comprising separating the low-glycemic syrup from the food solids mixture.

25. A method according to claim 24, wherein the low-glycemic syrup is separated by filtration, reverse osmosis, a chromatographic method, liquid-liquid extraction, or combinations thereof.

26. A method according to claim 24, wherein the alcohol-containing ingredient and the low-glycemic syrup are combined, thereby producing the low-glycemic alcoholic beverage.

27. A method according to claim 22, wherein the essence of a food comprises the flavors, aromas, colors, nutrients or combinations thereof of the food.

28. A method according to claim 27, wherein the essence of the food is derived from one or more fruits, vegetables, nuts, plants, any aspects thereof, or combinations thereof.

29. A method according to claim 28, wherein the aspect of the food is peel, rind, pulp, seed, juice, grain, bark, flower, spice, leaf, bean, herb, oleoresin, an extract, a concentrate, or combinations thereof.

30. A method according to claim 28, wherein the fruit is a citrus fruit, a tropical fruit, a berry, a drupaceous fruit, a gourd, a pome, a tomato, or combinations thereof.

31. A method according to claim 28, wherein the plant, or plant aspect, is coriander, wormwood, chinchena bark, elder flowers, angelica root, orris, alpine flowers, edelweiss, gentian, cloves, cardamon, fennel, thyme, cocoa, vanilla, nutmeg, cinnamon, armoise, quinine, chamomile, absinthe, sage, ginger, licorice, peppermint, spearmint, rosemary, parsley, soy bean, peanut, cola nut, or combinations thereof.

32. A method according to claim 28, wherein the nut is almond, cashew, hazel nut, walnut, Brazilian nut, or combinations thereof.

33. A method according to claim 28, wherein the vegetable is a sweet potato, sweet corn, squash, beet, carrot, cruciferous vegetable, or combinations thereof.

34. A method according to claim 18, wherein the low-glycemic component comprises a low glycemic substance selected from the group consisting of inulin, oligofructose, polydextrose, and combinations thereof.

35. A method according to claim 18, wherein the extraction enhancer is glycerin, propylene glycol, triacetin, or combinations thereof.

36. A method according to claim 18, wherein the ratio by weight of the extraction enhancer to the low-glycemic component ranges from about 1:3 to about 3:1.

37. A method according to claim 36, wherein the extraction enhancer is glycerin and the low-glycemic component is inulin.

38. A method according to claim 36, wherein the extraction enhancer is glycerin and the low-glycemic component is polydextrose.

39. A method according to claim 18, wherein the alcohol-containing ingredient is a grain alcohol, rum, tequila, brandy, marc, mescal, beer, wine or combinations thereof.

40. A method according to claim 39, wherein the grain alcohol is schnapps, vodka, whiskey, gin, kummel, aquavit, or a combinations thereof.

41. A method according to claim 18 further comprising a salt component.

42. A low-glycemic syrup comprising:
a) an essence of a food;
b) a low-glycemic component which is capable of extracting an essence of a food; and
c) a extraction enhancer.

43. A low-glycemic syrup according to claim 42, wherein the essence of a food comprises the flavors, aromas, colors, nutrients, or combinations thereof of the food.

44. A low-glycemic syrup according to claim 42, wherein the essence of the food is derived from one or more fruits, vegetables, nuts, plants, any aspects thereof, or combinations thereof.

45. A low-glycemic syrup according to claim 44, wherein the aspect of the food is peel, rind, pulp, seed, juice, grain, bark, flower, spice, leaf, bean, herb, oleoresin, an extract, a concentrate, or combinations thereof.

46. A low-glycemic syrup according to claim 44, wherein the fruit is a citrus fruit, a tropical fruit, a berry, a drupaceous fruit, a gourd, a pome, a tomato, or combinations thereof.

47. A low-glycemic syrup according to claim 44, wherein the plant, or plant aspect, is coriander, wormwood, chinchena bark, elder flowers, angelica root, orris, alpine flowers, edelweiss, gentian, cloves, cardamon, fennel, thyme, cocoa, vanilla, nutmeg, cinnamon, armoise, quinine, chamomile, absinthe, sage, ginger, licorice, peppermint, spearmint, rosemary, parsley, peanut, cola nut, soy bean, or combinations thereof.

48. A low-glycemic syrup according to claim 44, wherein the nut is almond, cashew, hazel nut, walnut, Brazilian nut, or combinations thereof.

49. A low-glycemic syrup according to claim 44, wherein the vegetable is a sweet potato, sweet corn, squash, beet, carrot, cruciferous vegetable, or combinations thereof.

50. A low-glycemic syrup according to claim 42, wherein the low-glycemic component comprises a low glycemic substance selected from the group consisting of inulin, oligofructose, polydextrose, and combinations thereof.

51. A low-glycemic syrup according to claim 42, wherein the extraction enhancer is glycerin, propylene glycol, triacetin, or combinations thereof.

52. A low-glycemic syrup according to claim 42, wherein the ratio by weight of the extraction enhancer to the low-glycemic component ranges from about 1:3 to about 3:1.

53. A low-glycemic syrup according to claim 52, wherein the extraction enhancer is glycerin and the low-glycemic component is inulin.

54. A low-glycemic syrup according to claim 52, wherein the extraction enhancer is glycerin and the low-glycemic component is polydextrose.

55. A low-glycemic syrup according to claim 42 further comprising a salt component.

56. A method of producing a low-glycemic syrup comprising combining a) a food source; b) a low-glycemic component; and c) an extraction enhancer.

57. A method according to claim 56, wherein the food source is whole, steeped, blanched, boiled, chopped, mashed, ground or blended.

58. A method according to claim 56, wherein the food source is enzymatically treated.

59. A method according to claim 56, wherein the food source, the low-glycemic component and the extraction enhancer are kept in contact for a time period that is sufficient to transfer the essence of the food source to the low glycemic component thereby forming the low-glycemic syrup.

60. A method according to claim 61, wherein the time period is from about a minute to about forty-eight hours.

61. A method according to claim 59, further comprising separating the low-glycemic syrup from the food source.

62. A method according to claim 61, wherein the low-glycemic syrup is separated by filtration, reverse osmosis, a chromatographic method, liquid-liquid extraction, or combinations thereof.

63. A method according to claim 59, wherein the essence of a food comprises the flavors, aromas, colors, nutrients, or combinations thereof of the food.

64. A method according to claim 59, wherein the essence of the food is derived from one or more fruits, vegetables, nuts, plants, any aspects thereof, or combinations thereof.

65. A method according to claim 64, wherein the aspect of the food is peel, rind, pulp, seed, juice, grain, bark, flower, spice, leaf, bean, herb, oleoresin, an extract, a concentrate, or combinations thereof.

66. A method according to claim 64, wherein the fruit is a citrus fruit, a tropical fruit, a berry, a drupaceous fruit, a gourd, a pome, a tomato, or combinations thereof.

67. A method according to claim 64, wherein the plant, or plant aspect, is coriander, wormwood, chinchena bark, elder flowers, angelica root, orris, alpine flowers, edelweiss, gentian, cloves, cardamon, fennel, thyme, cocoa, vanilla, nutmeg, cinnamon, armoise, quinine, chamomile, absinthe, sage, ginger, licorice, peppermint, spearmint, rosemary, parsley, soy bean, peanut, cola nut, or combinations thereof.

68. A method according to claim 64, wherein the nut is almond, cashew, hazel nut, walnut, Brazilian nut, or combinations thereof.

69. A method according to claim 64, wherein the vegetable is a sweet potato, sweet corn, squash, beet, carrot, cruciferous vegetable, or combinations thereof.

70. A method according to claim 56, wherein the low-glycemic component comprises a low glycemic substance selected from the group consisting of inulin, oligofructose, polydextrose, and combinations thereof.

71. A method according to claim 56, wherein the extraction enhancer is glycerin, propylene glycol, triacetin, or combinations thereof.

72. A method according to claim 56, wherein the ratio by weight of the extraction enhancer to the low-glycemic component ranges from about 1:3 to about 3:1.

73. A method according to claim 72, wherein the extraction enhancer is glycerin and the low-glycemic component is inulin.

74. A method according to claim 72, wherein the extraction enhancer is glycerin and the low-glycemic component is polydextrose.

75. A method according to claim 56 further comprising a salt component.
